(19) United States
(12) Patent Application Publication
(10) Pub. No.: US 2025/0297785 A1
(43) Pub. Date: Sep. 25, 2025

(54) METHODS AND SYSTEMS FOR HEAT TRANSFER USING FORMATION FLUIDS

(71) Applicant: GreenFire Energy Inc., Walnut Creek, CA (US)

(72) Inventors: Greg Szutiak, Calgary (CA); Alan D. Eastman, Walnut Creek, CA (US); John R. Muir, St. George, UT (US); Randy N. Balik, Walnut Creek, CA (US)

(73) Assignee: GreenFire Energy Inc., Walnut Creek, CA (US)

(21) Appl. No.: 19/088,794

(22) Filed: Mar. 24, 2025

Related U.S. Application Data
(60) Provisional application No. 63/569,443, filed on Mar. 25, 2024.

(51) Int. Cl. F24T 10/17; F24T 10/00

(52) U.S. Cl. CPC F24T 10/17; F24T 2010/56

(57) ABSTRACT

Methods and systems are disclosed herein. A method may include operating a closed-loop geothermal system disposed in a well. The well includes a wellbore penetrating the geothermal heat source, a casing string, a control valve, and a temperature sensor. An annulus is formed between the closed-loop geothermal system and the casing string. The method includes measuring, using the temperature sensor a first temperature of the geothermal fluid. The method includes opening, when the first temperature is lower than a first predetermined temperature, the control valve in order to discharge geothermal fluid from the annulus.

### BACKGROUND

Geothermal production system extract heat from the subsurface. This enables geothermal systems to produce power at any time during the day or night unlike other renewable energy sources such as wind and solar. However, the essential challenge of geothermal systems is extracting enough heat from the subsurface to ensure the system produces the requisite amount of energy over decades of use. One limiting determinant of system heat transfer is the rate of cooling of the geothermal fluids flowing from a hot subsurface rock formation to a surface through a cooler shallow rock formation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspects, the techniques described herein relate to a method for transferring heat from a geothermal heat source to the surface of the earth. The method includes operating a closed-loop geothermal system disposed in a well penetrating the geothermal heat source. The well includes a wellbore, a casing string, a control valve, and a temperature sensor. The wellbore penetrates the geothermal heat source. A first end of the casing string is open. A portion of the casing string penetrating the geothermal heat source is perforated permitting geothermal fluid to flow from the geothermal heat source into an annulus formed between the closed-loop geothermal system and the casing string. The control valve is configured to control the flow of geothermal fluid out of the annulus. The temperature sensor is configured to measure a first temperature of the geothermal fluid within the casing string. The method includes measuring a first temperature of the geothermal fluid. The method includes opening, when the first temperature is lower than a first predetermined temperature, the control valve to allow geothermal fluid to discharge from the annulus.

In some aspects, the techniques described herein relate to a system for transferring heat from a geothermal heat source to the surface of the earth. The system includes a closed-loop geothermal system disposed in a well penetrating the geothermal heat source. The well includes a wellbore, a wellbore, a casing string, a control valve, a temperature sensor, and a control system. The wellbore penetrates the geothermal heat source. A first end of the casing string is open. A portion of the casing string penetrating the geothermal heat source is perforated permitting geothermal fluid to flow from the geothermal heat source into an annulus formed between the closed-loop geothermal system and the casing string. The control valve is configured to control the flow of geothermal fluid out of the annulus. The temperature sensor is configured to measure a first temperature of the geothermal fluid. The control system is configured to open, when the first temperature is lower than a first predetermined temperature, the control valve to allow geothermal fluid to discharge from the annulus.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a heat transfer system with a closed-loop geothermal system in accordance with one or more embodiments.

FIG. 2 depicts a drilling system that may be used in relation to various embodiments.

FIG. 3A-D shows examples of a fluid conduit used in various embodiments.

FIG. 4A depicts a portion of a closed-loop geothermal system for heat transfer using a control valve in accordance with one or more embodiments.

FIG. 4B depicts an example temperature profile that may be measured by a heat transfer system in accordance with one or more embodiments.

FIG. 5 shows a flowchart depicting a method for heat transfer in accordance with one or more embodiments.

FIG. 6 depicts a computer system that may be used in relation to various embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details, or with other methods, components, materials, and so forth. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a fluid sample” includes reference to one or more of such samples.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

As used herein, the term “coupled” or “coupled to” or “connected” or “connected to” “attached” or “attached to” may indicate establishing either a direct or indirect connection, and is not limited to either unless expressly referenced as such.

As used herein, fluids may refer to slurries, liquids, gases, and/or mixtures thereof. It is to be further understood that the various embodiments described herein may be used in various stages of a well (land and/or offshore), such as rig site preparation, drilling, completion, abandonment etc., and in other environments, such as work-over rigs, fracking installation, well-testing installation, oil and gas production installation, without departing from the scope of the present disclosure.

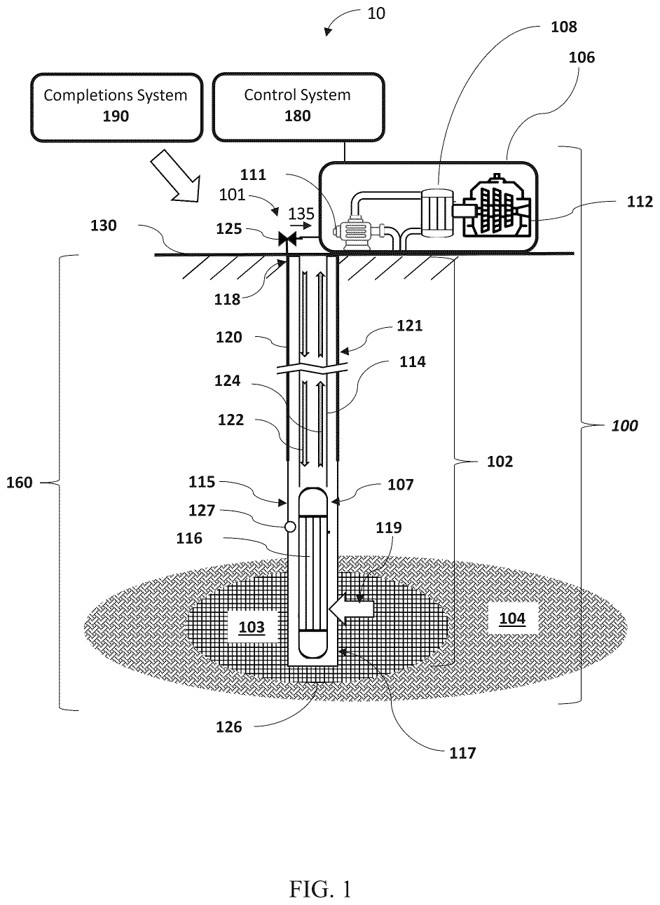

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Disclosed herein are methods and systems for heat transfer from a geothermal heat source to the surface of the earth. The methods and systems disclosed herein seek to improve efficiency of the closed-loop geothermal system by extracting heat from 1) a working fluid within the closed-loop geothermal system and 2) from a geothermal fluid flow through an annulus that is automatically regulated according to predetermined conditions. The heat transfer system includes transferring heat using a closed-loop geothermal system having a control valve to allow a flow of an annulus fluid to potentially increase heat production at a heat utilization facility. The control valve may be opened if a first temperature is higher than a first predetermined temperature. The control valve may be closed after extracting heat from the annulus fluid and a second temperature is lower than a second predetermined temperature.

FIG. 1 depicts a closed-loop geothermal system (100) that may be used in a system from a geothermal heat source to the surface of the earth (hereafter “heat transfer system”) (10). The heat transfer system (10) includes a well such as well (101) located at a wellsite.

In accordance with one or more embodiments, the closed-loop geothermal system (100) includes the well (101) having a wellbore (102) extending from a surface, such as the surface of the earth (130), to a geothermal heat source (104) and penetrating into a subterranean region of interest (hereafter “subsurface”) (160). Typically, the geothermal heat source (104) will be one or more rock formations characterized by an elevated temperature that may lie at intervals to a depth of several thousand feet below the surface of the earth (130). Often the rock formation may be a volcanic pluton, solidified from molten lava injected by volcanic or tectonic forces between the surrounding rock formations, and have a low fluid permeability. The wellbore (102) may be substantially vertical, as shown, or may be significantly deviated. The wellbore (102) may also have horizontal portions, or even have portions that become shallower with increasing distance along the wellbore (102). The wellbore (102) includes a plurality of depths. The plurality of depths may be measured along the wellbore (102) (e.g., a measured depth) or normal to the surface of the earth (e.g., total vertical depth).

Portions of a wellbore, such as wellbore (102) may be cased, typically with steel pipe, to form “cased hole” portions such as cased hole portion (121). Typically, at least the shallowest portions of the wellbore (102) may be cased to provide mechanical stability to the wellbore (102) and/or to isolate near-surface ground water, including drinking water aquifers from fluid originating at deeper depths and/or the drilling fluids used to create the wellbore (102). Often a casing string (120) having a first end (117) and a second end (118), will be cemented into place, using an annular sheath of cement between the exterior surface of the casing string (120) and the rock wall of the wellbore (102). In some cases, multiple sets of casing (not shown) may be present, disposed within one another and substantially sharing a common axis. In some embodiments, the first end (117) of the casing string (120) may be open, for example, a portion of the casing string (120) penetrating the geothermal heat source (104) is perforated permitting formation fluids such as geothermal fluid (103) to flow from the geothermal heat source (104) into the wellbore (102). In some embodiments, the second end (118) may be closed, i.e., the second end (118) of the casing string (120) may be fluid-tight. In some embodiments, the first end (117) may be located at a terminus of the wellbore (102) and the second end (118) may be located at the surface of the earth.

In some embodiments, portions of the wellbore (102) may be left uncased to create “openhole” portions (115) of the wellbore (102). While a casing string essentially isolates the interior of the cased hole portion (121) from the formation fluids (e.g., geothermal fluid (103)) in the surrounding rock formation and provides additional thermal insulation in the form of one or more layers of steel and cement, openhole portions (115) permit fluid, including hot fluid, and heat (119) to flow more easily into and out of the openhole portions (115). In some embodiments, the geothermal fluid may be liquid dominated, such as heated water. In other embodiments, the geothermal fluid may be steam dominated. Based on the disclosure herein, the geothermal fluid may be various phases (e.g., liquid or gas) and even mixed phases and the composition of the geothermal fluid is not meant to be limiting to the scope of the disclosure and claimed embodiments.

At, near, or above the surface of the earth (130) the wellbore (102) may connect to a heat utilization facility (106). The heat utilization facility (106) may include, without limitation, one or more heat exchangers, such as an uphole heat exchanger (108) to extract heat energy from hot working fluid (124), and/or one or more turbines, such as turbine (112) to generate electrical power. The turbine(s) may be connected to the uphole heat exchanger(s) or connected directly to the tubulars carrying hot working fluid (124) uphole via a transport line configured to transport geothermal fluids. In some embodiments, the geothermal fluid may be filtered and/or cleaned as known to those skilled in art before being transported to the turbines or other outputs.

In some embodiments, the heat utilization facility (106) may include facility equipment such as, for example, pipes, hoses, fittings, one or more sensors, heat exchangers, and various other equipment operatively coupled together as known to those skilled in the art. In some embodiments, the turbine(s) may be an expansion turbine configured to use a fluid such as gas or steam to generate power. The turbine (112) may expel waste fluids during operation. These waste fluids contain heat due to the operations of the turbine (112). In some embodiments, the waste fluids may be pumped, using an uphole pump such as uphole pump (111), into another offset wellbore to increase the heat content of fluid within the geothermal reservoir (104) and/or fluid flowing into the wellbore (102).

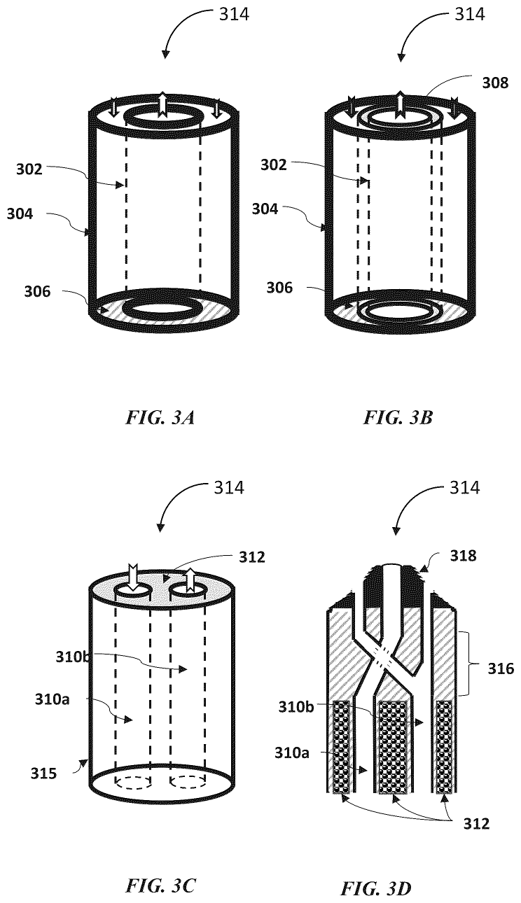

In accordance with one or more embodiments, a downhole heat exchanger (116) may be deployed within the wellbore (102). The downhole heat exchanger (116) may function to heat a cool working fluid (122) supplied to it by transferring heat (119) from hot geothermal fluid surrounding the downhole heat exchanger (116) and producing hot working fluid (124). Tubulars (pipes), such as fluid conduit (114), must fluidically connect the downhole heat exchanger (116) with the heat utilization facility (106) on the surface of the earth (130), and particularly with the uphole heat exchanger (108), allowing cool working fluid (122) to flow, or to be pumped, for example by uphole pump (111), into the wellbore, and hot working fluid (124) to flow uphole. The tubulars must be configured to allow cool working fluid (122) to flow in one direction and hot working fluid (124) to flow in the opposite direction without mixing with one another. This is generally accomplished by insulating the tubulars or placing an insulated material between them. Examples of designs for fluid conduits are shown below in FIGS. 3A-3D. An annulus (107) is formed between the closed-loop geothermal system (100) and the casing string (120).

Cool working fluid (122) may extract heat (119), for example using the downhole heat exchanger (116), from the geothermal heat source (104), i.e., the hot rock formation. However, particularly in low permeability rocks the extraction of heat (119) will cool the rock formation in a region surrounding the downhole heat exchanger (116), causing the temperature of this restricted zone (126) surrounding the downhole heat exchanger (116) to fall. Since many rocks are poor conductors of heat, and in low permeability rocks hot fluids cannot easily percolate into the restricted zone (126), the extracted heat (119) cannot be easily replaced from more distant portions of the geothermal heat source (104) and the efficacy of the closed-loop geothermal system (100) may decrease over time. However, embodiments herein having improved thermal conductivity pathways and with careful regulation of flow, the systems herein can reach a point of near equilibrium where the decline in power generation will be very slow over the lifecycle of the well such as well (101).

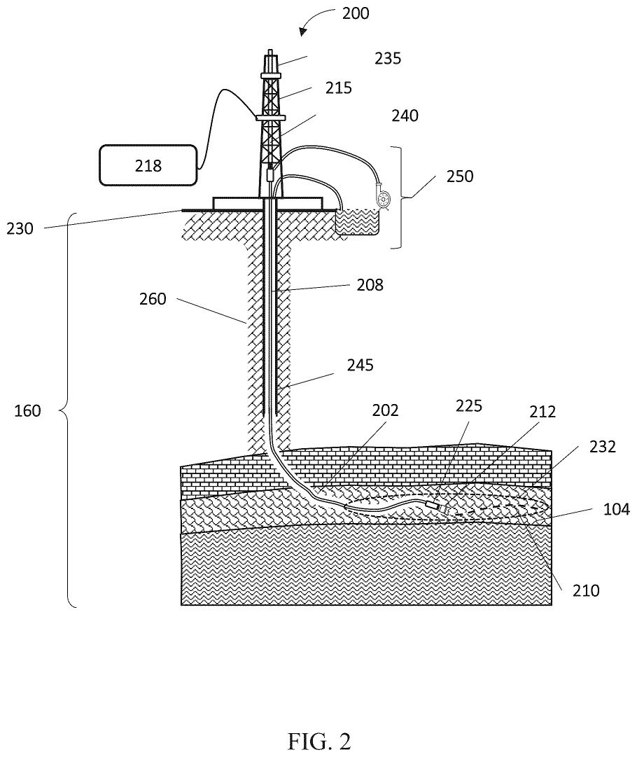

In some embodiments of the closed-loop geothermal system (100), a pre-existing wellbore may be used. For example, a wellbore previously drilled to provide fresh water, for geotechnical purposes, for geothermal purposes, or extended for the heat transfer system (10). In other embodiments, a wellbore such as the wellbore (102) may be drilled specifically for the construction of the heat transfer system (10) disclosed herein using a drilling system, such as drilling system (200) described in relation to FIG. 2. Based on the disclosure herein, it will be apparent to those skilled in the art that there are various configurations of a closed-loop geothermal system that may be used in the heat transfer system (10) and the closed-loop geothermal system (100) depicted in FIG. 1 should not be considered limiting to the disclosed invention.

In some embodiments, the closed-loop geothermal system (100) may include a control valve (125) configured to control the flow of geothermal fluid (103) out of the annulus (107). The control valve (125) may be operatively disposed, for example, at the second end (118) of the casing string (120) and one end (e.g., an inlet) of the control valve (125) may be fluidly connected to the annulus (107). The control valve (125) is operatively coupled to the casing string (120). The control valve (125) is configured to allow fluid flow (e.g., geothermal fluid (103)). When the control valve (125) is in an “open” position, the control valve (125) may allow fluid (e.g., geothermal fluid (103), drilling fluid, other formation fluids, etc.) to discharge from the annulus (107). Another end (e.g., an outlet) of the control valve (125) may be fluidly connected to various components (e.g., the uphole heat exchanger (108)) of the heat utilization facility (106) and configured to control the flow to the heat utilization facility (106). The control valve (125), when in a closed position, may form a fluid-tight seal and trap geothermal fluid (103) within the annulus (107) and not allow fluid (e.g., geothermal fluid (103)) to discharge from the annulus (107) through the second end (118).

The closed-loop geothermal system (100) may include a flowmeter configured to measure a flow rate (135) of fluid (e.g., geothermal fluid (103)) that has been discharged through the control valve (125). The flowmeter may be operatively connected to the closed-loop geothermal system. For example, the flowmeter may be disposed at a wellhead of the well (101) and operatively connected to the wellhead. In some embodiments, if the flow rate (135) of the discharged geothermal fluid (103) is lower than a predetermined flow rate, then the closed-loop geothermal system (100) may be configured to pump an annulus fluid in order to facilitate directing geothermal fluid (103) toward the control valve (125). For example, the closed-loop geothermal system (100) may include a downhole pump (not shown) known to those skilled in the art. The downhole pump may be disposed into the wellbore (102) with the downhole heat exchanger (116) and fluid conduit (114) and operatively connected to the control system (180). The control system (180) may be configured to operate the downhole pump.

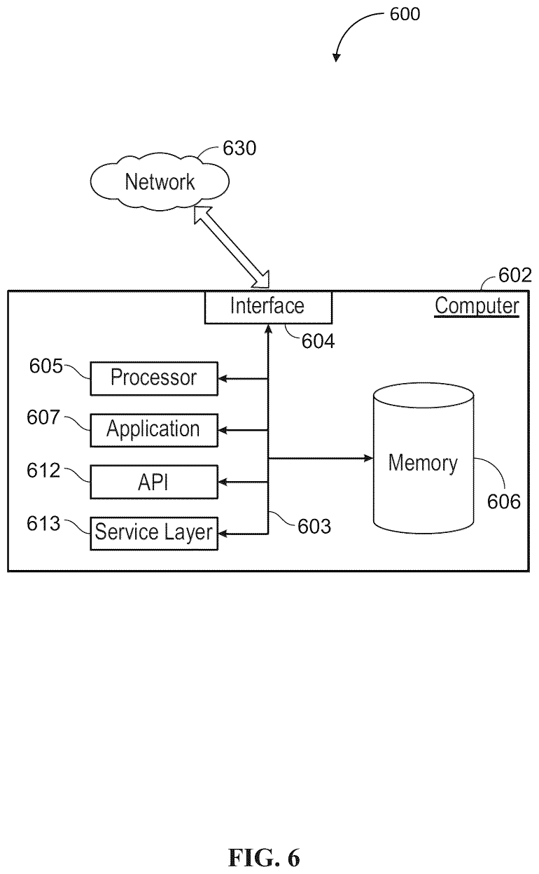

In some embodiments, the closed-loop geothermal system (100) may include a control system (180) configured to control various equipment and operations of the closed-loop geothermal system (100). For example, the control system (180) may be configured to open or close the control valve (125), and/or operate the various heat exchangers of the closed-loop geothermal system (100). As such the control system (180) may include various autonomous controllers positioned at and operatively connected to the corresponding equipment. In some embodiments, the control system (180) may be one or more computer systems, such as computer system (600) described in relation to FIG. 6, operatively connected to the equipment of the closed-loop geothermal system (100). The control system (180) may include hardware and/or software configured for performing geothermal system operations and any other specialized operations. Examples of hardware and/or software may include sensors, wires, cables, switches, routers, programmable logic controllers, microprocessors, and the like. The software may include geothermal specific software configured for sending instructions automatically and/or with user input to various equipment to perform geothermal system operations. In some embodiments, the software may also be configured to automate operations of the heat transfer system (10).

In some embodiments, the closed-loop geothermal system (100) may include a temperature sensor (127) disposed within the annulus (107) of the wellbore (102). The temperature sensor (127) may be any suitable temperature sensor that is rugged enough to withstand the temperatures and pressures within the wellbore (102). In some embodiments, the temperature sensor (127) may be disposed on the downhole heat exchanger (116). The temperature sensor (127) is operatively connected to the control system (180). The control system (180) is configured to receive temperature data (e.g., a first temperature and/or a second temperature) from the temperature sensor (127) and transmit instructions to the temperature sensor (127).

In some embodiments, a completions system (190) may be used to insert the downhole heat exchanger (116) and the fluid conduit (114) into the wellbore (102). The completions system (190) may include a rig configured to insert the downhole heat exchanger (116) and tubulars, such as the casing string (120) and the fluid conduit (114), into the wellbore (102). In some embodiments, the completions system (190) may include a specialized tubular insertion rig configured to handle the downhole heat exchanger (116), the fluid conduit (114) and/or the casing string (120) with greater precision and gentler handling than a typical rig so as not to damage any outer surface of tubulars, such as the casing string (120) and/or the fluid conduit (114), and provide improved connections between individual tubular sections.

While FIG. 1 shows various configurations of components, other configurations may be used without departing from the scope of the disclosure. For example, various components in FIG. 1 may be combined to create a single component. As another example, the functionality performed by a single component may be performed by two or more components.

FIG. 2 illustrates a drilling system (200) in accordance with one or more embodiments. In some embodiments, the drilling system (200) may be configured to drill a wellbore, such as wellbore (202) within a subterranean region of interest such as subsurface (160) guided by a wellbore drilling plan, that may include a planned wellbore path (210). The wellbore (202) may be newly drilled for construction of the heat transfer system (10). In some embodiments, the wellbore drilling plan may be designed such that the planned wellbore path (210) penetrates the location of the geothermal heat source (104) within the subsurface (160). The planned wellbore path (210), and the resulting wellbore (202) may include substantially vertical portions, deviated and highly deviated portions, and horizontal portions, without departing from the scope of the invention. The wellbore (202) may be drilled in order to receive the closed-loop geothermal system (100). In the present disclosure, substantially vertical may include, for example, a wellbore axis that is within 10 degrees of vertical in relation to the surface of the earth.

Although the drilling system (200) shown in FIG. 2 is depicted as drilling the wellbore (202) on land, the drilling system (200) may be a marine wellbore drilling system, including a jack-up rig, floating rig, semi-submersible rig, or drill-ship, without departing from the scope of the invention. Further, although the drilling system (200) shown in FIG. 2 is depicted as drilling the wellbore (202), the wellbore being drilled may be a sidetrack wellbore (not shown). As such, the example of the drilling system (200) shown in FIG. 2 is not meant to limit the disclosed and claimed invention.

As shown in FIG. 2, the drill rig may be equipped with a hoisting system, such as a derrick (215), which can raise or lower a drillstring (208) and other tools required to drill the wellbore (202). The drillstring (208) may include one or more drill pipes connected to form conduit and a bottom hole assembly (“BHA”) (225) disposed at the distal end of the drillstring (208). The BHA (225) may include a drill bit (212) to cut into rock (260). The BHA (225) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit (212), the weight-on-bit, and the torque. The LWD measurements may include sensors, such as resistivity, gamma ray, and neutron density sensors, to characterize the rock (260) surrounding the wellbore (202). Both MWD and LWD measurements may be transmitted to the surface of the earth (230) using any suitable telemetry system known in the art, such as a mud-pulse or by wired-drill pipe.

To start drilling, or “spudding in,” the wellbore (202), the hoisting system lowers the drillstring (208) suspended from the derrick (215) of the drill rig towards the planned surface location of the wellbore (202). An engine, such as a diesel engine, may be used to supply power to a top drive (235) to rotate the drillstring (208) via a drive shaft (240). The weight of the drillstring (208) combined with the rotational motion enables the drill bit (212) to bore the wellbore (202).

The near-surface rock of the subsurface (160) is typically made up of loose or soft sediment or rock, so large diameter casing (245) (e.g., “base pipe” or “conductor casing”) is often put in place while drilling to stabilize and isolate the near-surface wellbore. At the top of the base pipe is the wellhead (not shown), which serves to provide pressure control through a series of spools, valves, or adapters. Once near-surface drilling has begun, water or drill fluid may be used to force the base pipe into place using a pumping system until the wellhead is situated just above the surface of the earth (230).

Drilling may continue without any casing (245) once deeper or more compact rock (260) is reached. While drilling, a drilling mud system (250) may pump drilling mud from a mud tank on the surface of the earth (230) through the drill pipe. Drilling mud serves various purposes, including pressure equalization, removal of rock cuttings, and drill bit cooling and lubrication.

At planned depth intervals, drilling may be paused and the drillstring (208) withdrawn from the wellbore (202). Sections of casing (245) may be connected, inserted, and cemented into the wellbore (202). Casing string may be cemented in place by pumping cement and mud, separated by a “cementing plug,” from the surface of the earth (230) through the drill pipe. The cementing plug and drilling mud force the cement through the drill pipe and into the annular space between the casing (245) and the wall of the wellbore (202). Once the cement cures, drilling may recommence. The drilling process is often performed in several stages. Therefore, the drilling and casing cycle may be repeated more than once, depending on the depth of the wellbore (202) and the pressure on the walls of the wellbore (202) from surrounding rock (260).

Due to the high pressures experienced by deep wellbores, a blowout preventer (BOP) may be installed at the wellhead to protect the rig and environment from unplanned oil or gas releases. As the wellbore (202) becomes deeper, both successively smaller drill bits (212) and casing (245) may be used. Drilling deviated or horizontal wellbores may require specialized drill bits (212) or drill assemblies.

The drilling system (200) may be disposed at and communicate with other systems in the wellbore environment, such as the wellbore planning system (218). The drilling system (200) may control at least a portion of a drilling operation by providing controls to various components of the drilling operation. In one or more embodiments, the drilling system (200) may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target (232) within the geothermal heat source (104) is reached. The wellbore planning system (218) may include one or more computer system, such as computer system (600), described in relation to FIG. 6. The wellbore planning system (218) may include wellbore planning specific software as known to those skilled in the art.

The direction of a wellbore may be controlled by both active and passive directional drilling (or steering). In passive directional drilling the well trajectory is determined by the flexing or buckling of the drillstring (208) in response to the application of greater or lesser weight-on-bit and the design of the BHA (225). A conventional BHA equipped with multi-stabilizers may be used to control the hole deviation angle based on the lever principle or pendulum effect. However, the resulting wellbore path is also influenced by the natural features of strength or weakness of the rock formation and so the precision with which the wellbore trajectory can be controlled may be limited.

Active directional drilling may be performed using a variety of specialized BHA and drill bits known in the art. For example, BHA components known as “bent-subs” may hold the drill bit at a fixed orientation of a few degrees of deviation (typically, 1 or 2 degrees of angle) to the axis of the BHA. When the drillstring (208) is rotated the drill bit bores a portion of the wellbore (202) in a direction parallel to the axis of the BHA. In contrast, when the drillstring (208) is unrotated but the drill bit rotated by a motor (e.g., a mud-motor or an electrical motor) then the wellbore (202) is extended in the direction of orientation and the rate of deviation of the drill bit. Alternatively, wellbores may be deviated using rotatory steerable devices (RSD) that use continuously adjusted pressure pads on the BHA to push or point the drill bit, and hence the resulting wellbore, in the desired direction. Since RSDs work with the drillstring continuously rotating they are often preferred over bent-subs because of their superior drillstring drag-reduction and hole cleaning characteristics.

FIG. 3A-3D depict examples of bidirectional fluid conduit designs that may be used for the fluid conduits (114) in the closed-loop geothermal system (100) in accordance with one or more embodiments. FIG. 3A shows a first design for a bidirectional fluid conduit (314) that may be used for the fluid conduit (114) as shown in FIG. 1. In FIG. 3A the bidirectional fluid conduit design includes two co-axial pipes with a first pipe (302) disposed within a second pipe (304). In some embodiments, the total cross-sectional area of the second pipe (304) may be essentially double the cross-sectional area of the first pipe (302), so that the cross-sectional area through which fluid can flow in one direction within the first pipe (302) is equal to the cross-sectional area of a conduit annulus (306) through which fluid may flow in the reverse direction. For example, cool working fluid (122) may flow in a first direction (downhole) in the first pipe (302) while hot working fluid (124) may flow in the reverse direction (uphole) through the conduit annulus (306), or vice versa. The two pipes (302, 304) may form a closed-loop flow path to transport the working fluid between the uphole heat exchanger (108) and the downhole heat exchanger (116).

It is essential to thermally isolate the two fluids from one another as much as is practical. Accordingly, as shown in FIG. 3B a thermally insulating layer or insulating annulus (308) may be disposed between the first pipe (302) and the conduit annulus (306). Alternatively, thermal insulation may be created by construction of the first pipe (302) from a material exhibiting low thermal conductivity.

In other embodiments, the bidirectional fluid conduit (314) may include two pipes (310a) and (310b) of substantially equal cross-sectional areas running substantially parallel to each other side-by-side and embedded within a thermally insulating material (312) that in turn fills an exterior tubular (315), as shown in FIG. 3C. Typically, fluid conduits are manufactured in segments that may be 30-50 feet (ft) in length and such segments are screwed together as they are deployed in a wellbore such as wellbore (102) until they reach the desired length that may be several thousand feet in total. To allow the segments to be screwed together they may include a “male” screw thread (318), as shown in FIG. 3D, at one end and a corresponding “female” socket at the opposing end (not shown). Each segment may also include a cross-over section (316) at each end that transforms a side-by-side design to an annular form to facilitate the connect of the first pipe (310a) in a first segment to the first pipe in a second adjacent segment, and the second pipe (310b) in the first segment to the second pipe in the second adjacent segment. The two pipes (310a, 310b) may form a closed-loop flow path to transport the working fluid between the uphole heat exchanger (108) and the downhole heat exchanger (116).

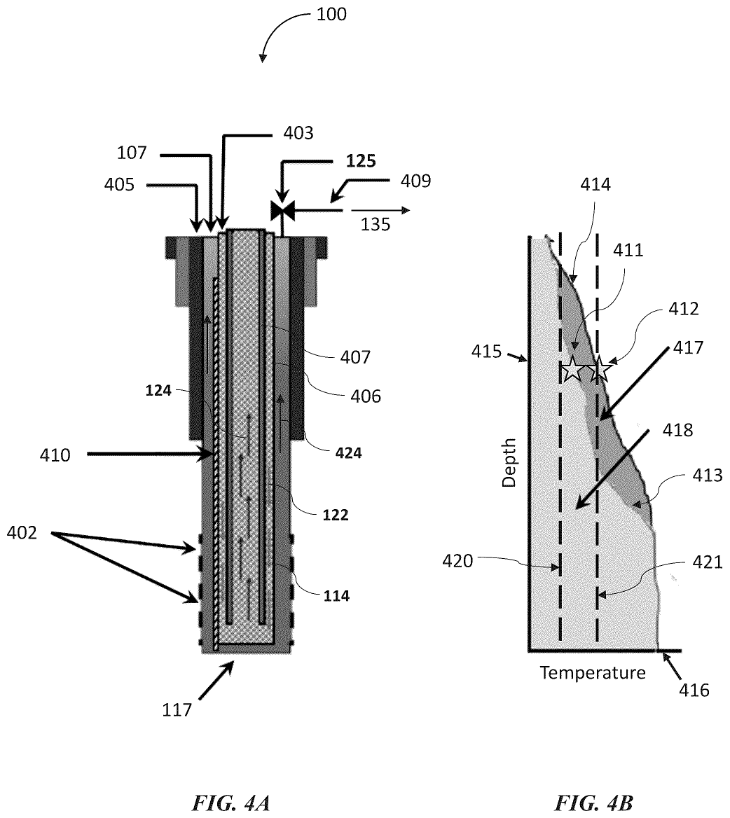

FIG. 4A depicts a portion of the closed-loop geothermal system (100) that includes a portion of a wellbore, such as the wellbore (102). Also shown of the closed-loop geothermal system (100) is an example well completions design that includes multiple casing strings, including casing string (405), and a perforated production liner (402) having perforations at or in proximity of the first end (117). For simplicity, various components of the closed-loop geothermal system (100) are not shown but it will be apparent to one skilled in the art the various components and their design that may be used with the portion of the closed-loop geothermal system (100). Well completions may include, but not limited to, casing strings, production liners, screens, perforations or some combination thereof. Based upon the disclosure provided herein, one or ordinary skill in the art will recognize a variety of well completion designs that may be used in relation to different embodiments for transferring heat (119) from geothermal fluid (103) and the well completions design shown is not meant to be limiting the scope of the disclosed and claimed invention.

In some embodiments, the temperature sensor (127) may include a fiber optic temperature sensor (410) configured to measure a temperature profile along a portion of the wellbore (102) of a formation fluid such as geothermal fluid (103). The fiber optic temperature sensor (410) may be disposed on the downhole heat exchanger (116) or on the casing. The fiber optic temperature sensor (410) is operatively connected to the control system (180). The control system (180) may be configured to receive temperature data (e.g., a first temperature profile and/or a second temperature profile) from the fiber optic temperature sensor (410) and transmit instructions to the fiber optic temperature sensor (410).

During normal operations, the closed-loop geothermal system (100) cycles working fluid through the fluid conduit (114) and the downhole heat exchanger (not shown). For example, cool working fluid (122) is flowed from the second end (118) to the first end (117) through conduit annulus (403) formed by the first pipe (406) and the second pipe (407) of a bidirectional fluid conduit. The first pipe (406) and the second pipe (407) are fluidly connected to a downhole heat exchanger, such as the downhole heat exchanger (116) as described in relation to FIG. 1, may be disposed, for example, at the first end (117) of the casing string (120). Heat (119) from geothermal fluid (103), is transferred to cool working fluid (122) using the downhole heat exchanger yielding hot working fluid (124). The hot working fluid (124) is then cycled toward the second end (118). Geothermal fluid (103) in proximity to a downhole heat exchanger such as downhole heat exchanger (116) may cool as hotter geothermal fluids may not replace the cool geothermal fluid at a rate sufficient to maintain a consistent temperature of geothermal fluid (103) in proximity of the downhole heat exchanger. In some embodiments, during operation, geothermal fluid (103) in proximity of the downhole heat exchanger may not have heat replace the heat extracted from geothermal fluid (103). Heat transfer from geothermal fluid (103) to the downhole heat exchanger is not optimal in these situations.

In accordance with one or more embodiments, when a temperature (e.g., a first temperature and/or a second temperature) of geothermal fluid (103) in proximity to the downhole heat exchanger (116) (e.g., geothermal fluid within the annulus (107)) cools below a predetermined temperature (e.g., a first predetermined temperature and/or a second predetermined temperature), then the heat transfer system (10) may alter normal operations to improve heat transfer from geothermal fluid (103) to replace the geothermal fluid below the first temperature with hotter geothermal fluid drawn from further away from the heat transfer system. In some embodiments, the control valve (125) may be opened to allow fluid within the annulus (107) to flow toward the surface of the earth. A portion of the fluid, such as an annulus fluid (424) (e.g., geothermal fluid as well as other formation fluids, drilling fluids, stimulation fluids, etc.), may be allowed to discharge through the control valve (125). In some embodiments, the discharged fluid may be directed, for example, toward and into the heat utilization facility (106) to transfer heat (119) from geothermal fluid (103) that has been discharged. A downhole pump (not shown) or an uphole pump such as uphole pump (111) may be used to facilitate directing the annulus fluid (424) including geothermal fluid (103) within the annulus (107) toward the surface of the earth (130) and/or the heat utilization facility (106) and thereby increasing the flow rate (135) of the discharging geothermal fluid (103). The downhole pump may be operatively connected to the control system (180). The control valve may be fluidly connected to the heat utilization facility (106) by flow line (409).

In some embodiments, the control valve (125) may be fluidly connected to various outputs through, for example, a manifold (not shown) configured to direct the geothermal fluid to various outputs. In some embodiments, the geothermal fluid may be directed to an uphole heat exchanger(s), turbine(s), uphole pump(s), an offset well, a discharge outlet for venting geothermal fluids, or a combination thereof. Based on the disclosure herein, it will be apparent to one skilled in the art that there are various uses for the geothermal fluid once discharged from the control valve and the uses listed here are not meant to be exhaustive nor limiting to the scope of the disclosure and claimed invention.

FIG. 4B shows a plot of example temperatures and temperature profiles that may be measured by the temperature sensor (127) and/or the fiber optic temperature sensor (410) in accordance with one or more embodiments. An initial temperature and/or initial temperature profile may be measured before operations commence. Temperatures (e.g., a first temperature (411) and/or a second temperature (412)) and temperature profiles (e.g., a first temperature profile (413) and/or a second temperature profile (414)) may be displayed, for example, on a temperature-depth plot with an X axis (415) representing depth (e.g., the measured depth or the total vertical depth) and a Y-axis (416) representing temperature measured, for example, in degrees using a Fahrenheit or Celsius scale). As the closed-loop geothermal system (100) is operating, geothermal fluid (103) within the annulus (107) of the wellbore (102) may cool as heat (119) is extracted from geothermal fluid (103) using the downhole heat exchanger (116). The temperature, such as the first temperature (411), and/or the temperature profile, such as the first temperature profile (413), may be measured after a predetermined time after commencing operation of the closed-loop geothermal system (100). An area (418) between the axes and the first temperature profile (413) is proportional to the potential heat recovered from the heat transfer processes using the downhole heat exchanger (116) of the closed-loop geothermal system (100). The first temperature (411) and/or the first temperature profile (413) may show a decrease in temperature relative to the initial temperatures after a first predetermined time of operation. In some embodiments, the temperatures (e.g., the first temperature (411) and/or a second temperature (412)) may be determined from the temperature profiles at a particular depth or may be an average of temperatures over a depth interval centered on a particular depth.

In accordance with one or more embodiments, the control valve (125) may be opened when the first temperature (411) is below a first predetermined temperature (420). The control system (180) may be configured to open the control valve (125) automatically when the first temperature (411) is below the first predetermined temperature (420). The control system (180) may be configured to determine whether the first temperature (411) is below a first predetermined temperature (420). A predetermined temperature (e.g., the first predetermined temperature (420) and/or the second predetermined temperature (412)) may be based on a temperature decrease (e.g., a percentage of decrease and/or a total amount of decrease) or may be a predetermined temperature based on a user input entered into the control system (180) using a user interface (not shown). A predetermined temperature that optimizes heat production may be determined during operation of the closed-loop geothermal system and the control valve (125). When the control valve (125) is opened, a portion of the geothermal fluid (103) discharges through the control valve (125) and is directed toward, for example, the heat utilization facility (106) in order to transfer heat (119) from the discharged geothermal fluid (103) to the uphole heat exchanger (108). As a portion of geothermal fluid (103) discharges, fresh geothermal fluid from the formation may replace the discharged geothermal fluid thereby raising a temperature in the proximity of the downhole heat exchanger (116).

In accordance with or more embodiments, the second temperature (412) and/or the second temperature profile (414) may be measured after a second predetermined time. The second temperature (412) and/or the second temperature profile (414) may show an increase in temperature relative to the first temperature (411) and/or the first temperature profile (413). An area (417) between the first temperature profile (413) and the second temperature profile (414) may be proportional to the additional heat potential from allowing the geothermal fluid (103) to discharge at the surface of the earth to the heat utilization facility (106). In some embodiments, the control valve (125) may be closed after a predetermined volume of annulus fluid is allowed to discharge through the control valve (125). In some embodiments, the control valve (125) may be closed after a predetermined time interval while annulus fluid is allowed to discharge through the control valve (125). In some embodiments, the control valve (125) may be closed after a predetermined surface temperature of the discharged annulus fluid has been reached.

In accordance with one or more embodiments, the control valve (125) may be closed when the second temperature (412) is higher than a second predetermined temperature (421). The control system (180) may be configured to close the control valve (125) automatically when the second temperature (412) is higher than the second predetermined temperature (421). The control system (180) may be configured to determine if the second temperature (412) is higher than the second predetermined temperature (421). When the control valve (125) is closed, normal operation of the closed-loop geothermal system (100) continues transferring heat (119) from geothermal fluid (103) to the working fluid via the downhole heat exchanger (116).

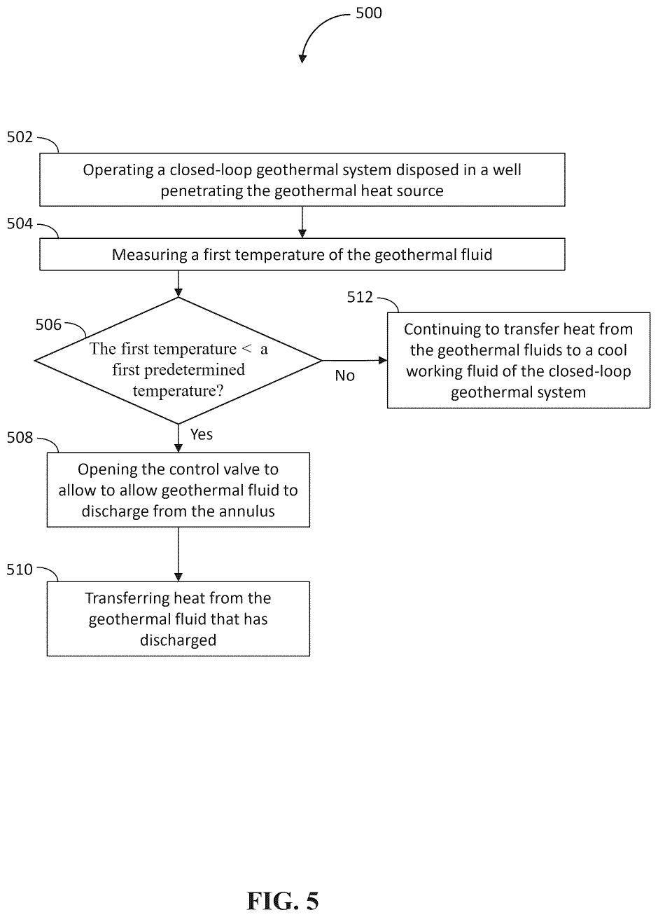

FIG. 5 depicts a flowchart in accordance with one or more embodiments describing a method for heat transfer (hereafter “heat transfer method”) (500). In some embodiments, the heat transfer method (500) may use the heat transfer system (10). Although the steps in flowchart using the heat transfer method (500) are shown in sequential order, it will be apparent to one of ordinary skill in the art that some steps may be conducted in parallel, in a different order than shown, or may be omitted without departing from the scope of the invention.

In box (502), the heat transfer method (500) includes operating the closed-loop geothermal system (100) disposed in a well, such as well (101), penetrating the geothermal heat source (104) in accordance with one or more embodiments. Operating the closed-loop geothermal system (100) may include transferring heat (119) from geothermal fluids (103) to cool working fluid (122) using the downhole heat exchanger (116).

In box (504), the heat transfer method (500) includes measuring the first temperature (411) of geothermal fluid (103) in accordance with one or more embodiments. The first temperature (411) may be measured by the temperature sensor (127) configured to measure the first temperature (411). Measuring the first temperature (411) may include using the temperature sensor (127) to measure one or more temperatures over a first predetermined time interval and then averaging the one or more temperatures to obtain the first temperature (411). In some embodiments, the temperature sensor (127) may be the fiber optic temperature sensor (410) configured to measure a temperature profile (e.g., the first temperature profile (413) and/or the second temperature profile (414)). The control system (180) may be configured to determine the first temperature (411) from the first temperature profile (413). In some embodiments, the first temperature (411) may be determined from the first temperature profile (413) by selecting the first temperature (411) at a particular depth along the first temperature profile (413).

In box (506), the heat transfer method (500) may include determining, using the control system (180), whether the first temperature (411) is lower than the first predetermined temperature (420). The control system (180) is configured to determine whether the first temperature (411) is lower than the first predetermined temperature (420). The control system (180) may include a comparator configured to compare temperatures (e.g., the first temperature (411) and/or the second temperature (412)) to the predetermined temperatures (e.g., the first predetermined temperature (420) and/or the second predetermined temperature (421)). In box (512), the heat transfer method (500) may include continuing to transfer heat (119) from geothermal fluid (103) to cool working fluid (122) of the closed-loop geothermal system (100) when the first temperature (411) is not lower than the first predetermined temperature (420). The heat transfer method (500) may repeat box (504) until the first temperature (411) is lower than the first predetermined temperature (420).

In box (508), the heat transfer method (500) includes opening, when the first temperature (411) is lower than the first predetermined temperature (420), the control valve (125) to allow a portion of geothermal fluid (103) to discharge from the annulus through the control valve (125) in accordance with one or more embodiments. The control system (180) is configured to open, when the first temperature (411) is lower than the first predetermined temperature (420), the control valve (125) to allow a portion of geothermal fluid (103) to discharge from the annulus through the control valve (125). In some embodiments, the heat transfer method (500) may include controlling the heat transfer automatically when the first temperature (411) is lower than the first predetermined temperature (420) such as opening the control valve (125) automatically.

In some embodiments, measuring a temperature (e.g., the first temperature (411) and/or the second temperature (412)) may include determining the temperature from the temperature profile (e.g., the first temperature profile (413) and/or the second temperature profile (414)). In some embodiments, determining the first temperature (411) may include performing a mathematical operation on at least a portion of the first temperature profile (413) such as averaging over a depth interval along the first temperature profile (413).

In box (510), the heat transfer method (500) includes transferring heat from geothermal fluid (103) that has discharged using the uphole heat exchanger (108) in accordance with one or more embodiments. The uphole heat exchanger may be fluidly connected to the control valve (125). Geothermal fluid (103) may discharge with the control valve (125) in the open position, either partially or fully opened.

In some embodiments, the heat transfer method (500) may include measuring the second temperature (412) of geothermal fluid (103). The second temperature (412) may be measured by the temperature sensor (127) configured to measure the second temperature (412). Measuring the second temperature (412) may include using the temperature sensor (127) to measure one or more temperatures over a second predetermined time interval and then averaging the one or more temperatures to obtain the second temperature (412). In some embodiments, the temperature sensor (127) may be the fiber optic temperature sensor (410) configure to measure the second temperature profile (414). The control system (180) may be configured to determine the second temperature (412) from the second temperature profile (414). In some embodiments, determining the second temperature (412) may include performing a mathematical operation on at least a portion of the second temperature profile (414) such as averaging over a depth interval along the second temperature profile (414).

In some embodiments, the heat transfer method (500) may include closing, when the second temperature (412) is higher than the second predetermined temperature (421), the control valve (125) to choke geothermal fluid (103) from discharging from the annulus (107). The control system (180) is configured to close, when the second temperature (412) is higher than the second predetermined temperature (421), the control valve (125) to trap geothermal fluid (103) from discharging from the annulus (107). The heat transfer method (500) includes continuing to operate the closed-loop geothermal system (100) after the control valve (125) is closed.

In some embodiments, the heat transfer method (500) may include determining the flow rate of discharging geothermal fluid (103). The heat transfer method (500) may include determining whether the flow rate (135) is below a predetermined flow rate. The heat transfer method (500) may include pumping, using a pump, and a control fluid if the flow rate is below the production threshold. The control fluid may be any suitable fluid for facilitating a flow rate of a well. For example, the control fluid may be water, carbon dioxide gas, and the like.

In some embodiments, the heat transfer method (500) may include directing the geothermal fluid (103) to a turbine, such as turbine (103), to potentially be used for generating power. The turbine (112) may be configured to use the geothermal fluid (103) to generate electrical power. The turbine (112) may be, for example, an expansion turbine, and may produce waste fluids during the process of generating electrical power. The waste fluids from an outlet of a turbine(s), such as turbine (112), may be pumped into an offset wellbore, using an uphole pump, such as the uphole pump (111), in order to potentially add additional heat into the geothermal reservoir (104) and/or the wellbore (102).

Embodiments may be implemented on a computer system. FIG. 6 is a block diagram of a computer system (600) including a computer (602) used to provide computational functionalities associated with described algorithms, methods, functions, processes, flows, and procedures as described in the instant disclosure, according to an implementation. The illustrated computer (602) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602)) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or other suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (604 includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that can be connected to the network (630). For example, memory (606) can be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602).

There may be any number of computers (602) associated with, or external to, a computer system containing computer (602), each computer (602) communicating over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

Embodiments of the present disclosure may provide at least one of the following advantages. The present invention provides a system for transferring heat so that heat transfer is maximized for various benefits such as, for example, production of power. The present invention provides a method for directing heat transfer between geothermal fluids and a downhole heat exchanger and/or an uphole heat exchanger in order to maximize the heat transfer.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for transferring heat from a geothermal heat source to the surface of the earth, comprising:
operating a closed-loop geothermal system disposed in a well penetrating the geothermal heat source, wherein the well comprises:
a wellbore penetrating the geothermal heat source,
a casing string,
wherein a first end of the casing string is open;
wherein a portion of the casing string penetrating the geothermal heat source is perforated permitting geothermal fluid to flow from the geothermal heat source into an annulus formed between the closed-loop geothermal system and the casing string; and
a control valve controlling the flow of geothermal fluid out of the annulus, and
a temperature sensor configured to measure a first temperature of the geothermal fluid within the casing string,
measuring the first temperature of the geothermal fluid; and
opening, when the first temperature is lower than a first predetermined temperature, the control valve to allow geothermal fluid to discharge from the annulus.

2. The method according to claim 1, wherein the temperature sensor comprises a fiber optic temperature sensor configured to measure a temperature profile along a portion of the wellbore.

3. The method according to claim 2, wherein measuring the first temperature comprises determining the first temperature from the temperature profile.

4. The method according to claim 1, further comprising transferring heat from the geothermal fluid that has discharged using an uphole heat exchanger.

5. The method according to claim 1, further comprising transporting the geothermal fluid to a turbine configured to generate electrical energy.

6. The method according to claim 1, further comprising:
measuring a second temperature of the geothermal fluid; and
closing, using a control system, the control valve when the second temperature is higher than a second predetermined temperature, to choke geothermal fluid from discharging from the annulus.

7. The method according to claim 1, further comprising continuing to transfer heat from the geothermal fluid to a working fluid of the closed-loop geothermal system if the first temperature is not lower than the first predetermined temperature.

8. The method according to claim 1, wherein the wellbore comprises a substantially vertical wellbore.

9. The method according to claim 1, further comprising controlling a heat transfer automatically when the first temperature is lower than the first predetermined temperature.

10. The method according to claim 1, wherein allowing geothermal fluid to discharge comprises pumping a control fluid in order to facilitate directing the geothermal fluid toward the control valve.

11. A system for transferring heat from a geothermal heat source to the surface of the earth, comprising:
a closed-loop geothermal system disposed in a well penetrating the geothermal heat source, wherein the well comprises:
a wellbore penetrating the geothermal heat source,
a casing string,
wherein a first end of the casing string is open;
wherein a portion of the casing string penetrating the geothermal heat source is perforated permitting geothermal fluid to flow from the geothermal heat source into an annulus formed between the closed-loop geothermal system and the casing string; and
a control valve fluidly connected to the annulus and configured to control the flow of geothermal fluid out of the annulus,
a temperature sensor configured to measure a first temperature of the geothermal fluid;
a control system configured to open, when the first temperature is lower than a first predetermined temperature, the control valve to allow geothermal fluid to discharge from the annulus.

12. The system according to claim 11, wherein the temperature sensor comprises a fiber optic temperature sensor configured to measure a temperature profile along a portion of the wellbore.

13. The system according to claim 12, wherein the control system is further configured to determine the first temperature from the temperature profile.

14. The system according to claim 11, wherein the closed-loop geothermal system further comprises an uphole heat exchanger configured to transfer heat from the geothermal fluid that has discharged.

15. The system according to claim 11, a transport line fluidly connected to the control valve and configured to transport the geothermal fluid to a turbine configured to generate electrical energy.

16. The system according to claim 11,
wherein the temperature sensor is further configured to measure a second temperature of the geothermal fluid,
wherein the control system is further configured to close, when the second temperature is lower than a second predetermined temperature, the control valve to choke geothermal fluid from discharging from the annulus.

17. The system according to claim 11, the closed-loop geothermal system is further configured to continue to transfer heat from the geothermal fluid to a working fluid of the closed-loop geothermal system if the first temperature is not lower than the first predetermined temperature.

18. The system according to claim 11, wherein the wellbore is a substantially vertical wellbore.

19. The system according to claim 11, wherein the control system is configured to control a heat transfer automatically when the first temperature is lower than the first predetermined temperature.

20. The system according to claim 11, further comprising a pump configured to pump a control fluid in order to facilitate flowing the geothermal fluid to the surface of the earth.
